(19) United States
(12) Patent Application Publication
(10) Pub. No.: US 2012/0196108 A1
(43) Pub. Date: Aug. 2, 2012

(54) HIGH PERFORMANCE BALLISTIC COMPOSITES HAVING IMPROVED FLEXIBILITY AND METHOD OF MAKING THE SAME

(75) Inventors: ASHOK BHATNAGAR, RICHMOND, VA (US); BRIAN D. ARVIDSON, CHESTER, VA (US); DAVID A. HURST, RICHMOND, VA (US); DANELLE F. POWERS, CHESTERFIELD, VA (US); DAVID A. STEENKAMER, MIDLOTHIAN, VA (US); HENRY G. ARDIFF, CHESTERFIELD, VA (US)

(73) Assignee: HONEYWELL INTERNATION INC., Morristown, NJ (US)

(21) Appl. No.: 13/078,406

(22) Filed: Apr. 1, 2011

Related U.S. Application Data
(63) Continuation-in-part of application No. 11/823,570, filed on Jun. 28, 2007, now Pat. No. 7,919,418.
(60) Provisional application No. 60/843,868, filed on Sep. 12, 2006.

(51) Int. Cl. B32B 5/26; B32B 7/02

(52) U.S. Cl. 428/218; 428/221

(57) ABSTRACT

Flexible ballistic resistant composite materials are described, having any of a number of important properties, or a combination of properties, including flexibility, comfort, weight, and/or ballistic performance. Representative composite materials comprise a plurality of fibrous layers, such as non-woven fibrous layers, with these fibrous layers comprises fibers (e.g., a network of fibers) having a tenacity of at least about 35 g/d and a tensile modulus of at least about 1200 g/d. Representative fibers include, for example, high tenacity poly(alpha-olefin) fibers. The fibrous layers also comprise a polymeric matrix deposited on the fibers. Advantageously, such composite materials may have an average total areal density per fibrous layer from about 16 g/m² to about 350 g/m², and often from about 16 g/m² to about 300 g/m², in addition to meeting flexural rigidity and/or stiffness criteria as described herein.

### CROSS-REFERENCE TO RELATED APPLICATIONS

This application is a continuation-in-part of U.S. application Ser. No. 11/823,570, filed Jun. 28, 2007, now allowed, which claims the benefit of U.S. Provisional application Ser. No. 60/843,868, filed Sep. 12, 2006. Each of these prior applications is hereby incorporated by reference in its entirety.

### BACKGROUND OF THE INVENTION

1. Field of the Invention

This invention relates to high performance ballistic composite materials having improved flexibility and other important properties, to armor products comprising the composite materials, and to processes for making these materials and armor products.

2. Description of Related Art

Ballistic resistant products for vests and the like are known in the art. Many of these products are based on high tenacity fibers, such as extended chain polyethylene fibers. Body armor, such as bullet-resistant vests, may be formed from rigid composites and/or flexible composites.

Rigid body armor provides good ballistic resistance, but is also very stiff and relatively bulky. As a result, in general, rigid body armor garments (e.g., vests) are usually less comfortable to wear than flexible body armor garments. Rigid body armor is also referred to as “hard” armor, which has been defined in the art (see, for example, U.S. Pat. No. 5,690,526) to mean an article, such as a helmet or panels for military vehicles, which has sufficient mechanical strength so that it maintains structural rigidity when subjected to a significant amount of stress and is capable of being free-standing without collapsing. In contrast to such rigid or hard armor, is flexible or “soft” armor which does not have the attributes associated with the hard armor previously mentioned. Flexible armor, for example, is therefore generally incapable of being free-standing without collapsing. Although flexible body armor based on high tenacity fibers has excellent service experience, its ballistic performance is generally not as high as that of hard armor. If higher ballistic performance is desired in flexible armor, generally speaking the flexibility of such armor is decreased.

Various attempts have been made to produce flexible ballistic composites, such as providing permanent creases in a fibrous web as is disclosed in U.S. Pat. No. 5,124,195 to Harpell et al., and providing textured surfaces as is described in U.S. Pat. No. 5,567,498 to McCarter et al.

It would be desirable to provide a flexible ballistic resistant composite material which has improved flexibility, comfort, weight, and ballistic performance. It would also be desirable to provide an armor product, such as body armor, based on such a material which likewise has improved flexibility and ballistic performance. Such armor desirably would be comfortable to wear and not costly to manufacture.

### SUMMARY OF THE INVENTION

In accordance with this invention, there is provided a flexible ballistic resistant composite material having any of a number of important properties, or a combination of properties, including flexibility, comfort, weight (or areal density), and/or ballistic performance. Representative composite materials comprise a plurality of fibrous layers, such as non-woven fibrous layers. At least one of (e.g., two or more of, or all of) these fibrous layers comprises fibers (e.g., a network of fibers) having a tenacity of at least about 35 g/d and a tensile modulus of at least about 1200 g/d. Representative fibers include, for example, high tenacity poly(alpha-olefin) fibers. The fibrous layers may also comprise a polymeric matrix deposited on the fibers, and preferably all fibrous layers of the composite comprise a polymeric matrix. Advantageously, the composite material has an average total areal density per fibrous layer from about 16 g/m² to about 350 g/m², and often from about 16 g/m² to about 300 g/m². In more particular embodiments, each of the fibrous layers of the composite has a total areal density within these ranges.

According to embodiments of the invention, (i) with respect to a two-layer structure of the composite, the structure has a flexural rigidity of less than about 5.2 g-cm, (ii) with respect to a four-layer structure of the composite, the structure has a flexural rigidity of less than about 20.1 g-cm, (iii) with respect to a six-layer structure of the composite, the structure has a flexural rigidity of less than about 47.1, and (iv) with respect to an eight-layer structure of the composite, the structure has a flexural rigidity of less than about 86 g-cm, wherein the flexural rigidity is measured according to ASTM D 1388.

According to other embodiments of the invention, (i) with respect to a two-layer structure of the composite, the structure has a stiffness of less than about 2.6 pounds (1.18 kg), (ii) with respect to a four-layer structure of the composite, the structure has a stiffness of less than about 3.9 pounds (1.77 kg), (iii) with respect to a six-layer structure of the composite, the structure has a stiffness of less than about 6.4 pounds (2.90 kg), and (iv) with respect to an eight-layer structure of the composite, the structure has a stiffness of less than about 10 pounds (4.54 kg), wherein the stiffness is measured according to ASTM D 4032.

According to further embodiments of the invention, the composite has a stiffness of less than about 2.5 pounds (1.14 kg) for a two-layer structure of the composite, and/or a stiffness of less than about 3.0 pounds (1.36 kg) for a four-layer structure of the composite, wherein the stiffness is measured according to ASTM D 4032. According to yet further embodiments of the invention, the composite has a total areal density equal to or less than about 100 g/m² and for a two-layer structure of the composite, and/or a total areal density equal to or less than about 190 g/m² for a four-layer structure of the composite. According to still further embodiments of the invention, the fiber areal density, in each of the plurality of fibrous layers of the composite material, is from about 15 g/m² to about 250 g/m².

A representative polymeric matrix is an elastomer having a tensile modulus of about 41.4 MPa or less, as measured according to ASTM D 638. Particular examples of a polymeric matrix include polybutadiene, polyisoprene, natural rubber, an ethylene copolymer (e.g., ethylene-propylene copolymer), an ethylene-propylene-diene terpolymer, a polysulfide polymer, a polyurethane elastomer, chlorosulfonated polyethylene, polychloroprene, plasticized polyvinylchloride, a butadiene acrylonitrile elastomer, poly(isobutylene-co-isoprene), a polyarcylate, a polyester, a polyether, a silicone elastomer, and blends thereof. Other examples of a polymeric matrix include block copolymers of a conjugated diene monomer (e.g., butadiene or isoprene) and a vinyl aromatic monomer (e.g., styrene, vinyl toluene, or t-butyl styrene). Such block copolymers include styrene-isoprene-styrene block copolymers that may be modified, for example, with wood rosin or a wood rosin derivative. The polymeric matrix may be deposited on the fibers as an aqueous composition.

According to particular embodiments of the invention, there is provided a flexible ballistic resistant composite material having any of the properties (e.g., improved flexibility), or combinations of properties, as described above. The composite material comprises a plurality of non-woven fibrous layers, and the fibrous layers comprise a network of high tenacity poly(alpha-olefin) fibers having a tenacity of at least about 35 g/d and a tensile modulus of at least about 1200 g/d. The fibers are in a matrix comprising a block copolymer of a conjugated diene and a vinyl aromatic monomer that is deposited on the fibers as an aqueous composition. The composite has a total areal density equal to or less than about 100 g/m² and a stiffness of less than about 2.5 pounds (1.14 kg) for a two-layer structure of the composite, and a total areal density equal to or less than about 190 g/m² and a stiffness of less than about 3.0 pounds (1.36 kg) for a four-layer structure of the composite, wherein the stiffness is measured according to ASTM D 4032. The composite has a Peel Strength of less than about 0.45 kg (1.0 pounds) for a two-layer structure of the composite, and less than about 0.32 kg (0.7 pounds) for a four-layer structure of the composite. The term “Peel Strength” is defined below.

According to further embodiments of the invention, there is provided a flexible ballistic resistant composite material having any of the properties (e.g., improved flexibility), or combinations of properties, as described above. The composite material comprises a plurality of fibrous layers, and fibers of at least one of (e.g., two or more of, or all of) the fibrous layers are high tenacity fibers. The flexible ballistic composite may have one or more of the features described above, including fiber tenacity; fiber tensile modulus; resin matrix type; total areal density for two-layer and four-layer structures of the composite; stiffness for two-layer, four-layer, six-layer, and eight-layer structures of the composite; flexural rigidity for two-layer, four-layer, six-layer, and eight-layer structures of the composite; and/or Peel Strength. According to particular embodiments of the invention, when assembled together (e.g., in a stacked relationship in a flexible armor product such as a vest) a plurality of the composites meets at least one of the following ballistic criteria:

(a) for a total weight of the armor product of 3.68 kg/m² or less, when impacted with a 124 grain, 9 mm full metal jacket bullet:

(i) for a plurality of the composites (comprising, for example, from 2-layer to 8-layer structures of the composite), a V50 of at least about 488 meters per second (mps), and often least about 519 mps; and/or

(b) for a total weight of the armor product of 3.68 kg/m² or less, when impacted with a 240 grain, 44 magnum semi-jacketed hollow point bullet:

(ii) for a plurality of the composites (comprising, for example, from 2-layer to 8-layer structures of the composite), a V50 of at least about 458 mps, and often at least about 473 mps); and/or

(c) for a total weight of the armor product of 4.89 kg/m² or less, when impacted with a 17 grain Fragment Simulating Projectile meeting the specifications of MIL-P-46593A (ORD):

(iii) for a plurality of the composites (comprising, for example, from 2-layer to 8-layer structures of the composite), a V50 of at least about 556 mps, and often at least about 572 mps).

Yet further embodiments of the invention are directed to flexible ballistic resistant armor products comprising one or more of the composite materials described above. The composite materials may, for example, be assembled in a stacked relationship and each comprise, for example, from about 2 to about 8 fibrous layers. The ballistic properties of such armor products may be as described in (a), (b), and/or (c) above, with respect to the performance of a plurality of composites as may be used in the armor products. As a result of the fibers, polymeric matrix, ratios of these components, and other factors, armor products according to embodiments of the invention advantageously have not only excellent flexibility, weight, and ballistic performance properties, but also desirable overall system flexibility (or “drapability”) that is sought in military and law enforcement applications. For example, exemplary armor products have an overall system flexibility of less than about 250 g-cm, and often less than about 225 g-cm, which may be determined as the sum of the flexural rigidities, measured according to ASTM D 1388, of individual composite materials that are assembled in the armor product as layers in a stacked relationship. This overall system flexibility may be achieved, for example, in armor products having a one or more of the same type and/or one or more different types of composite materials. Representative flexible ballistic armor products may comprise from about 40 to about 150, and often from about 50 to about 135, total fibrous layers in the system of composite materials, assembled in a plurality of layers. Such products may be obtained, for example, by assembling sufficient two-ply, four-ply, six-ply, and/or eight-ply composites in a stacked relationship (e.g., assembling 13 layers of four-ply composites to obtain an armor product having 52 total fibrous layers).

According to a particular embodiment, a flexible ballistic resistant armor product comprises a composite material having a plurality of fibrous layers. The fibrous layers comprise fibers and a polymeric matrix deposited on the fibers. Fibers of a least one of the plurality of fibrous layers have a tenacity of at least about 35 g/d and a tensile modulus of at least about 1200 g/d. The composite materials may have an average total areal density per fibrous layer from about 16 g/m² to about 350 g/m². Advantageously, the armor product has an overall system flexibility of less than about 250 g-cm, determined as described above. Preferably, the armor product comprises a plurality of composite materials assembled in a stacked relationship.

Still further embodiments of the invention are directed to methods for the manufacture of flexible ballistic resistant composite materials as described above. The methods comprise coating a first fiber layer, comprising high tenacity fibers having a tenacity of at least about 35 g/d and a tensile modulus of at least about 1200 g/d, with a polymeric matrix as described above; coating the second fiber layer with a polymeric matrix as described above; and consolidating the first and second resulting fibrous layers to form a composite material having one or more of the features described above, including fiber tenacity; fiber tensile modulus; resin matrix type; total areal density for two-layer and four-layer structures of the composite; stiffness for two-layer, four-layer, six-layer, and eight-layer structures of the composite; flexural rigidity for two-layer, four-layer, six-layer, and eight-layer structures of the composite; and/or Peel Strength.

The flexible composite materials described herein may additionally comprise flexible films on one or both sides of each structure, for example a two-ply, a four-ply, a six-ply, or an 8-ply structure, with the number of plies referring to the number of fibrous layers. Adjacent fibrous layers of the composite material may be arranged such that the directions of the fibers are rotated, for example at about 90° or other desired orientation, relative to one another.

The present invention provides composite materials having any of a number of advantageous properties and features, or combinations of properties and features, as discussed above. The composite materials advantageously exhibit excellent ballistic performance and yet have desirable flexibility, comfort, and weight (areal density) properties. Surprisingly, it has been found that the combination of fiber and polymeric matrix, together with the content of the matrix and other factors (e.g., the manner of assembling the composite materials) provides these desirable properties, or properties in combination, which were not heretofore attainable. The process described herein permit fabrication of these composite materials in a cost-effective manner.

### DETAILED DESCRIPTION

The present invention is directed to composite materials having good flexibility, comfort, weight, and/or ballistic resistance properties. These composite materials are particularly useful in ballistic resistant flexible armor articles, such as body armor (e.g., vests), blankets, curtains and the like.

Representative composite materials comprise at least two fibrous layers of high tenacity fibers in a polymeric matrix. For the purposes of the present invention, a fiber is an elongate body, the length dimension of which is much greater that the transverse dimensions of width and thickness. Accordingly, the term fiber includes monofilament, multifilament, ribbon, strip, staple, and other forms of chopped, cut, or discontinuous fiber and the like having regular or irregular cross-section. The term “fiber” includes a plurality of any of the foregoing or a combination thereof. A yarn is a continuous strand comprised of many fibers or filaments.

Representative fibers may, for example, be formed from ultra-high molecular weight poly(alpha-olefins). These polymers and the resultant fibers and yarn include polyethylene, polypropylene, poly(butene-1), poly(4-methyl-pentene-1), their copolymers, blends and adducts. For the purposes of the invention, an ultra-high molecular weight poly(alpha-olefin) is defined as one having an intrinsic viscosity when measured in decalin at 135° C. of from about 5 to about 45 dl/g.

The fibers may be circular, flat or oblong in cross-section. They also may be of irregular or regular multi-lobal cross-section having one or more regular or irregular lobes projecting from the linear or longitudinal axis of the filament. It is particularly preferred that the fibers be of substantially circular, flat or oblong cross-section, most preferably that the fibers be of substantially circular cross-section.

As used herein, the term “high tenacity fibers” means fibers having a tenacity equal to or greater than about 35 grams/denier (g/d). These fibers preferably have initial tensile moduli of at least about 1200 g/d and an ultimate elongation of at least about 2.5%, as measured by ASTM D2256. Preferred fibers are those having a tenacity equal to or greater than about 36 g/d, a tensile modulus equal to or greater than about 1250 g/d and an ultimate elongation of at least about 2.9%. Particularly preferred fibers are those having a tenacity of at least 36 g/d, a tensile modulus of at least 1285 g/d, and an elongation of at least 3.0%. As used herein, the terms “initial tensile modulus,” “tensile modulus,” and “modulus” mean the modulus of elasticity as measured by ASTM 2256 for a yarn and by ASTM D638 for a polymeric matrix.

The networks of fibers used in composites of the present invention may be in the form of woven or non-woven fabrics formed from the aforementioned high tenacity fibers. A particularly preferred configuration of the fibers is in a network of non-woven fibers that are unidirectionally aligned, such that the fibers are substantially parallel to each other along a common fiber direction. Preferably, at least about 50% by weight of the fibers in the non-woven fabric or composite material, or in the fibrous layers of the composite material, are high tenacity fibers. More preferably at least about 75% by weight of the fibers in the fabric or composite material, or in the fibrous layers of the composite material, are the high tenacity fibers. Most preferably, substantially all of the fibers in the fabric or composite material, or in the fibrous layers of the composite material, are the high tenacity fibers described above.

The high strength fibers particularly useful in the yarns, composite materials, and/or fibrous layers are preferably highly oriented high molecular weight high modulus polyethylene fibers (also known as extended chain polyethylene) and highly oriented high molecular weight high modulus polypropylene fibers. Most preferred are extended chain polyethylene fibers.

The yarns, composite materials, and/or fibrous layers may be comprised of one or more different high strength fibers. Preferably, however, the yarns and fabrics of the invention are formed from the same high strength fiber. The yarns may be in essentially parallel alignment, or the yarns may be twisted, over-wrapped or entangled.

The yarns and fibers may be of any suitable denier. For example, they may have a denier of from about 50 to about 3000 denier, more preferably from about 200 to about 3000 denier, still more preferably from about 400 to about 3000 denier, yet more preferably from about 400 to about 2800 denier, even more preferably from about 650 to about 1700 denier, and most preferably from about 1100 to about 1600 denier.

U.S. Pat. No. 4,457,985 generally discusses such high molecular weight polyethylene and polypropylene fibers, and the disclosure of this patent is hereby incorporated by reference to the extent that it is not inconsistent herewith. In the case of polyethylene, suitable fibers are those of weight average molecular weight of at least about 150,000, preferably at least about one million and more preferably between about two million and about five million Such high molecular weight polyethylene fibers may be spun in solution (see U.S. Pat. No. 4,137,394 and U.S. Pat. No. 4,356,138), or a filament spun from a solution to form a gel structure (see U.S. Pat. No. 4,413,110, German Off. No. 3,004,699 and GB Patent No. 2051667), or the polyethylene fibers may be produced by a rolling and drawing process (see U.S. Pat. No. 5,702,657). As used herein, the term polyethylene means a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as antioxidants, lubricants, ultraviolet screening agents, colorants and the like which are commonly incorporated.

High tenacity polyethylene fibers are preferred and are sold under the trademark SPECTRA® by Honeywell International Inc. of Morristown, N.J., USA.

Depending upon the formation technique, the draw ratio and temperatures, and other conditions, a variety of properties can be imparted to these fibers. The highest values for initial tensile modulus and tenacity are generally obtainable only by employing solution grown or gel spinning processes. Many of the filaments have melting points higher than the melting point of the polymer from which they were formed. Thus, for example, high molecular weight polyethylene of about 150,000, about one million and about two million molecular weight generally have melting points in the bulk of 138° C. The highly oriented polyethylene filaments made of these materials have melting points of from about 7° C. to about 13° C. higher. Thus, a slight increase in melting point reflects the crystalline perfection and higher crystalline orientation of the filaments as compared to the bulk polymer.

Similarly, highly oriented high molecular weight polypropylene fibers of weight average molecular weight at least about 200,000, preferably at least about one million and more preferably at least about two million may be used. Such extended chain polypropylene may be formed into reasonably well oriented filaments by the techniques prescribed in the various references referred to above, and especially by the technique of U.S. Pat. No. 4,413,110. Since polypropylene is a much less crystalline material than polyethylene and contains pendant methyl groups, tenacity values achievable with polypropylene are generally substantially lower than the corresponding values for polyethylene. Accordingly, a suitable tenacity is preferably at least about 8 g/d, more preferably at least about 11 g/d. The initial tensile modulus for polypropylene is preferably at least about 160 g/d, more preferably at least about 200 g/d. The melting point of the polypropylene is generally raised several degrees by the orientation process, such that the polypropylene filament preferably has a main melting point of at least 168° C., more preferably at least 170° C. The particularly preferred ranges for the above described parameters can advantageously provide improved performance in the final article. Employing fibers having a weight average molecular weight of at least about 200,000 coupled with the preferred ranges for the above-described parameters (modulus and tenacity) can provide advantageously improved performance in the final article.

A particularly preferred fiber is one that has the following properties: tenacity of 36.6 g/d, a tensile modulus of 1293 g/d, and an ultimate elongation of 3.03 percent. Also preferred is a yarn having a denier of 1332 and 240 filaments.

The ballistic resistant composite material is preferably in the form of a non-woven fabric, such as plies of unidirectionally oriented fibers, or fibers which are felted in a random orientation and which are embedded in a suitable resin matrix. Composite materials formed from unidirectionally oriented fibers typically have one fibrous layer having fibers that extend in one direction and a second fibrous layer having fibers that extends in a direction 90° from the fibers in the first fibrous layer. Where fibers of the individual plies or fibrous layers are unidirectionally oriented, the orientations in successive plies are preferably rotated relative to one another, for example at angles of 0°/90°, 0°/90°/0°/90°, or 0°/45°/90°/45°/0° or at other angles.

It is convenient to characterize the geometries of the composite materials of the invention by the geometries of the fibers. In one suitable arrangement, a fibrous layer has fibers that are aligned parallel to one another along a common fiber direction (referred to as a “unidirectionally aligned fiber network”). Successive fibrous layers having such unidirectionally aligned fibers can be rotated with respect to the previous fibrous layer. Preferably, the fibrous layers of the composite material are cross-plied, that is, with the fiber direction of the unidirectional fibers of each fibrous layer rotated with respect to the fiber direction of the unidirectional fibers of the adjacent fibrous layers. An example is a composite material comprising five fibrous layers, with fiber orientation of the second, third, fourth and fifth fibrous layers being rotated +45°, −45°, 90° and 0° with respect to that of the first fibrous layer. A preferred example includes two fibrous layers with a 0°/90° lay-up. Such rotated unidirectional alignments are described, for example, in U.S. Pat. Nos. 4,457,985; 4,748,064; 4,916,000; 4,403,012; 4,623,574; and 4,737,402.

In general, the fibrous layers of the invention are preferably formed by constructing a fiber network initially and then coating the network with the polymeric matrix composition. As used herein, the term “coating” is used in a broad sense to describe a fiber network wherein the individual fibers either have a continuous layer of the matrix composition surrounding the fibers or a discontinuous layer of the matrix composition on the surface of the fibers. In the former case, it can be said that the fibers are fully embedded in the matrix composition. The terms coating and impregnating are interchangeably used herein. The fiber networks can be constructed via a variety of methods. In the preferred case of unidirectionally aligned fiber networks, yarn bundles of the high tenacity filaments are supplied from a creel and led through guides into a collimating comb and one or more spreader bars prior to coating with the polymeric matrix composition. The collimating comb aligns the fibers coplanarly and in a substantially unidirectional fashion.

Methods according to embodiments of the invention include initially forming the fiber network layer, preferably a unidirectional network as described above, applying a solution, dispersion or emulsion of the polymeric matrix composition onto the fiber network layer, and then drying the matrix-coated fiber network layer. The solution, dispersion, or emulsion is often an aqueous product of the matrix composition, which may be sprayed onto the fibers. Alternatively, the fibers may be coated with the aqueous solution, dispersion or emulsion by dipping or by means of a roll coater or the like. After coating, the coated fibrous layer may then be passed through an oven for drying in which the coated fiber network layer (“unitape”) is subjected to sufficient heat to evaporate a solvent (e.g., water) in the polymeric matrix composition. The coated fibrous network may then be placed on a carrier web, which can be a paper or a film substrate, or the fibers may initially be placed on a carrier web before coating with the polymeric matrix composition. The substrate and the consolidated unitape can then be wound into a continuous roll in a known manner.

The consolidated unitape can be cut into discrete sheets and laid up into a stack for formation into the end use composite material. As mentioned previously, the most preferred composite material is one wherein the fiber network of each layer is unidirectionally aligned and oriented so that the fiber directions in successive layers are in a 0°/90° orientation.

The fibers in each adjacent fibrous layer may be the same or different, although it is preferred that the fibers in each two adjacent fibrous layers of the composite be the same.

The polymeric matrix deposited on the fibers in the fibrous layers may be selected from a wide variety of materials, including elastomers. A preferred elastomeric matrix composition comprises a low modulus elastomeric material. For the purposes of this invention, a low modulus elastomeric material has a tensile modulus, measured at about 6,000 psi (41.4 MPa) or less according to ASTM D638 testing procedures. Preferably, the tensile modulus of the elastomer is about 4,000 psi (27.6 MPa) or less, more preferably about 2400 psi (16.5 MPa) or less, more preferably 1200 psi (8.23 MPa) or less, and most preferably is about 500 psi (3.45 MPa) or less. The glass transition temperature (Tg) of the elastomer is preferably less than about 0° C., more preferably the less than about −40° C., and most preferably less than about −50° C. The elastomer also has a preferred elongation to break of at least about 50%, more preferably at least about 100% and most preferably has an elongation to break of at least about 300%. The value for elongation to break often exceeds 1000% for polymeric matrix compositions that are suitable for flexible ballistic resistant composite materials as described herein.

A wide variety of materials and formulations having a low modulus may be utilized in the polymeric matrix composition. Representative examples include polybutadiene, polyisoprene, natural rubber, ethylene copolymers (e.g., ethylene-propylene copolymers), ethylene-propylene-diene terpolymers, polysulfide polymers, polyurethane elastomers, chlorosulfonated polyethylene, polychloroprene, plasticized polyvinylchloride, butadiene acrylonitrile elastomers, poly(isobutylene-co-isoprene), polyacrylates, polyesters, polyethers, silicone elastomers, and combinations thereof, and other low modulus polymers and copolymers. Also preferred are blends of different elastomeric materials, or blends of elastomeric materials with one or more thermoplastics.

Particularly useful polymeric matrix compositions are block copolymers of conjugated dienes and vinyl aromatic monomers. Butadiene and isoprene are preferred conjugated diene elastomers. Styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple tri-block copolymers of the type A-B-A, multi-block copolymers of the type (AB)ₙ (n=2-10) or radial configuration copolymers of the type R-(BA)ₓ (x=3-150); wherein A is a block from a polyvinyl aromatic monomer and B is a block from a conjugated diene elastomer. Many of these polymers are produced commercially by Kraton Polymers of Houston, Tex. and described in the bulletin “Kraton Thermoplastic Rubber,” SC-68-81. The most preferred low modulus polymeric matrix materials comprise styrenic block copolymers, particularly polystyrene-polyisoprene-polystrene-block copolymers (or styrene-isoprene-styrene block copolymers), sold under the trademark KRATON® commercially produced by Kraton Polymers. Kraton®D and Kraton®G, for example, are styrenic block copolymer rubbers, namely block copolymers with styrene end blocks and midblocks which can be ethylene-butylene (S-EB-S), isoprene (SIS), or butadiene (SBS). Kraton®G1657 is a 13/87 styrene/rubber ratio three block copolymer with styrene endblocks and a rubbery (ethylene-butylene) midblock (S-EB-S) wherein the midblock is saturated. Kraton®D1101 is a styrene-butylene-styrene (SBS) with a styrene/rubber ratio of 31/69. Kraton®D1107 is a styrene-isoprene-styrene (SIS) with a styrene/rubber ratio of 14/86.

A particularly useful polymeric matrix composition is a water based dispersion of any of the resins described herein, such as a dispersion of Kraton®D1107 styrene-isoprene-styrene elastomer, which preferably contains less than about 0.5 weight percent retained organic solvent. Typical total solids content of such dispersions may range from about 30 to about 60 weight percent, more preferably from about 35 to about 50 weight percent, and most preferably from about 40 to about 45 weight percent. The solids content may be diluted if desired by the addition of water, or it may be increased if desired by the addition of viscosity modifiers and the like. A typical dispersion has a viscosity of about 400 cps as measured at 77° F. (25° C.), and has a particle size ranging from 1-3 μm. Conventional additives such as fillers and the like may be included in the elastomeric composition. Suitable dispersions may also contain a wood rosin derivative as a resin modifier, a surfactant, and/or an antioxidant.

An exemplary polymeric matrix composition for use in composite materials described herein is a styrene-isoprene-styrene block copolymer that is modified with wood rosin or a wood rosin derivative. Such compositions include Prinlin® products (Pierce & Stevens, Varitech Division, Buffalo, N.Y.), which are water based dispersions of Kraton® rubber. Prinlin®B7137X-1, for example, is Kraton®D1107 modified with a wood rosin derivative. Prinlin®B7138A is Kraton®G1657 modified with wood rosin and hydrogenated rosin ester. Prinlin®B7138AD is Kraton®G1657/FG1901, a styrene-ethylene-butylene-styrene (S-EB-S). Prinlin®B7248A is Kraton®F1901, a S-EB-S copolymer. Prinlin®B7216A is Kraton®D 1101 modified with wood rosin and hydrogenated rosin ester.

Further exemplary polymers for use in polymeric matrix compositions include a polyurethane polymer, a polyether polymer, a polyester polymer, a polycarbonate resin, a polyacetal polymer, a polyamide polymer, a polybutylene polymer, an ethylene-vinyl acetate copolymer, an ethylene-vinyl alcohol copolymer, an ionomer, a styrene-isoprene copolymer, a styrene-butadiene copolymer, a styrene-ethylene/butylene copolymer, a styrene-ethylene/propylene copolymer, a polymethyl pentene polymer, a hydrogenated styrene-ethylene/butylene copolymer, a maleic anhydride functionalized styrene-ethylene/butylene copolymer, a carboxylic acid functionalized styrene-ethylene/butylene copolymer, an acrylonitrile polymer, an acrylonitrile butadiene styrene copolymer, a polypropylene polymer, a polypropylene copolymer, an epoxy resin, a phenolic resin (e.g., a novolac resin), a vinyl ester resin, a silicone resin, a nitrile rubber polymer, a natural rubber polymer, a cellulose acetate butyrate polymer, a polyvinyl butyral polymer, an acrylic polymer, an acrylic copolymer or an acrylic copolymer incorporating non-acrylic monomers.

Preferred acrylic polymers non-exclusively include acrylic acid esters, particularly acrylic acid esters derived from monomers such as methyl acrylate, ethyl acrylate, n-propyl acrylate, 2-propyl acrylate, n-butyl acrylate, 2-butyl acrylate and tert-butyl acrylate, hexyl acrylate, octyl acrylate and 2-ethylhexyl acrylate. Preferred acrylic polymers also particularly include methacrylic acid esters derived from monomers such as methyl methacrylate, ethyl methacrylate, n-propyl methacrylate, 2-propyl methacrylate, n-butyl methacrylate, 2-butyl methacrylate, tert-butyl methacrylate, hexyl methacrylate, octyl methacrylate and 2-ethylhexyl methacrylate. Copolymers and terpolymers made from any of these constituent monomers are also preferred, along with those also incorporating acrylamide, n-methylol acrylamide, acrylonitrile, methacrylonitrile, acrylic acid and maleic anhydride. Also suitable are modified acrylic polymers modified with non-acrylic monomers. For example, acrylic copolymers and acrylic terpolymers incorporating suitable vinyl monomers such as: (a) olefins, including ethylene, propylene and isobutylene; (b) styrene, N-vinylpyrrolidone and vinylpyridine; (c) vinyl ethers, including vinyl methyl ether, vinyl ethyl ether and vinyl n-butyl ether; (d) vinyl esters of aliphatic carboxylic acids, including vinyl acetate, vinyl propionate, vinyl butyrate, vinyl laurate and vinyl decanoates; and (f) vinyl halides, including vinyl chloride, vinylidene chloride, ethylene dichloride and propenyl chloride. Vinyl monomers which are likewise suitable are maleic acid diesters and fumaric acid diesters, in particular of monohydric alkanols having 2 to 10 carbon atoms, preferably 3 to 8 carbon atoms, including dibutyl maleate, dihexyl maleate, dioctyl maleate, dibutyl fumarate, dihexyl fumarate and dioctyl fumarate.

Acrylic polymers and copolymers are especially suitable for use in resin matrix compositions due to their hydrolytic stability, which is believed to result from the straight carbon backbone of these polymers. Acrylic polymers are also preferred because of the wide range of physical properties available in commercially produced materials. The range of physical properties available in acrylic resins matches, and perhaps exceeds, the range of physical properties thought to be desirable in polymeric binder compositions of ballistic resistant composite matrix resins.

The amount of the polymeric matrix (e.g., as a water based composition) that is deposited on the fibers is chosen to achieve a desired level of resin content, relative to fiber content, in each of the fibrous layers and ultimately in the flexible ballistic resistant composite material. In the case of a dispersion, the amount of the polymeric matrix composition used depends upon the solids content and the percentage of the polymeric material in the solids. This amount is desirably chosen such that the proportion of the polymeric matrix to fiber in the fibrous layers of the composite is lower than conventionally employed in commercial products. Preferably, the polymeric matrix, on a solids basis, preferably forms about 7 to about 25 percent by weight, more preferably from about 10 to about 22 percent by weight, even more preferably from about 12 to about 20 percent by weight, and most preferably from about 14 to about 18 percent by weight, of each fibrous layer. These representative ranges also apply to the amount of polymeric matrix present in the composite material itself.

In the flexible ballistic resistant composite materials described herein, the fiber areal density per fibrous layer or ply refers to the weight of the fibers only (not including the matrix) per unit area. The fiber areal density contributes to the overall lightweight characteristics of the composite materials, as well as armor products comprising these composite materials.

According to representative embodiments, composite materials have a fiber areal density, in each of the plurality of fibrous layers, generally from about 15 g/m² to about 250 g/m², typically from about 20 g/m² to about 100 g/m², and often from about 25 g/m² to about 70 g/m². According to particular embodiments, the composite materials have a fiber areal density, in each of the plurality of fibrous layers, from about 28 g/m² to about 54 g/m².

The composite materials of this invention may be formed from individual fibrous layers (lamina) by consolidating under heat and pressure, such as, for example, at temperatures ranging from about 24 to about 127° C. (about 75° C. to about 260° F.), pressures of from about 6.9 to about 1725 kPa (about 1 psi to about 250 psi) and for a time of from about 1 to about 30 minutes.

The number of fibrous layers in the composite material depends on the particular end use, and generally ranges from about 2 to about 20 fibrous layers, and typically from about 2 to about 8 fibrous layers. According to exemplary embodiments, the composite is formed from two, four, six, or eight fibrous layers, with adjacent fibrous layers preferably being oriented 90° (i.e., cross-plied) with respect to each other and consolidated into a single structure. For example, the composite may be formed from two sets of structures, each having two cross-plied fibrous layers, such that a total of four fibrous layers are employed; in this case, two of the two-ply consolidated structures are consolidated with one another to form the composite.

Representative ballistic resistant composite materials desirably include one or more plastic films, in order to permit separate composite materials, for example in an armor product comprising a plurality of composite materials, to slide over each other for ease of forming into a body shape and ease of wearing. These plastic films may typically be adhered to one or both exterior surfaces of the outermost fibrous layers of a composite material. Any suitable plastic film may be employed, with preferred films being formed from polyolefins. Examples of such films are linear low density polyethylene (LLDPE) films, ultrahigh molecular weight polyethylene (UHMWPE) films, polyester films, nylon films, polycarbonate films and the like. These films may be of any desirable thickness. Typical thicknesses range from about 2.5 to about 30 μm (about 0.1 to about 1.2 mils), more preferably from about 5 to about 25 μm (about 0.2 to about 1 mil), and most preferably from about 6.3 to about 12.7 μm (0.25 to about 0.5 mils) Most preferred are films of LLDPE.

Exemplary composite materials according to the present invention are two-ply, four-ply, six-ply, or eight-ply laminates (having two, four, six, or eight fibrous layers, respectively) that are cross-plied at 0°/90° and have films of LLDPE on both exterior surfaces. A four-ply laminate, for example, may be a combination of two layers of the two-ply laminate previously mentioned. Such a four-ply laminate may also have LLDPE films on both exterior surfaces.

The number of layers of composite materials that may be used in articles (e.g., flexible ballistic resistant armor products) formed therefrom varies depending upon the ultimate use of the article. Preferably, flexible ballistic resistant composite materials as described herein, for example one or a plurality of such composite materials assembled in a stacked relationship (e.g., with adjacent lateral surfaces facing one another), are used to form the outer facing layers of body armor, such as a vest, but alternatively they may form the inner layers. The number of two-ply, four-ply, six-ply, eight-ply, and/or other types of the composite materials, having any number of plies or fibrous layers, is chosen to provide a desired areal density in the final product, considering the desired performance, weight and cost. For example, in body armor vests, in order to achieve a desired approximate 4.89 kg/m² (1.0 pound per square foot) areal density, in one typical construction there may be a total of about 51 of the two-ply composite construction or about 27 of the four-ply composite construction, assembled in a stacked relationship. In another typical embodiment in body armor vests, in order to achieve a desired approximate 3.68 kg/m² (0.75 pound per square) foot areal density, there may be a total of about 39 of the two-ply composite construction or about 21 of the four-ply composite construction, assembled in a stacked relationship. The areal density of the vest or other ballistic resistant article, such as an armor product, may be of any desired amount, such as from about 1.47 to 4.89 kg/m² (0.30 to about 1.0 pounds per square foot), more preferably from about 1.47 to 3.91 kg/m² (0.30 to about 0.80 pounds per square foot). In general, the number of two-ply composites, assembled in a stacked relationship, in a flexible ballistic armor product preferably ranges from about 15 to about 65 of such composites, more preferably from about 20 to about 55 of such composites; and the number of four-ply composites, assembled in a stacked relationship, preferably ranges from about 8 to about 33 of such composites, more preferably from about 15 to about 30 of such composites.

As described herein with respect to armor products comprising composite materials “assembled in a stacked relationship,” this includes embodiments in which the composite materials, as described herein, have adjacent lateral surfaces facing one another. This also includes embodiments in which other materials (e.g., other types of composite materials) may be placed between these composite materials of the present invention, such that their adjacent lateral surfaces are not directly in contact. This also includes embodiments in which such other materials are disposed at one or both outermost surfaces of a plurality of composite materials of the present invention that have lateral surfaces facing each other. In any armor products, the fibers used in the fibrous layers of the composites are preferably extended chain polyethylene fibers.

An important property that correlates with the overall comfort of the user of flexible ballistic resistant armor products, including vests and other protective clothing, as well as blankets, is known as flexural rigidity (or “drapability”). Values for this property, as provided herein, are determined according to ASTM D 1388, Standard Test Method for Stiffness of Fabrics, for measuring flexural rigidity in units of g-cm. In particular, the flexural rigidity of a composite material is the average value (in cm-g) of the flexural rigidity as measured in the warp direction (G_{i,warp}) and the flexural rigidity as measured in the fill direction (G_{i,fill}). Representative composites used to form armor products, as well as representative armor products themselves, have desirable flexural rigidity values, in terms of being below certain threshold values. In the case of composites as described herein, for example, (i) with respect to a two-layer structure of the composite, the structure has a flexural rigidity of less than about 5.2 g-cm, (ii) with respect to a four-layer structure of the composite, the structure has a flexural rigidity of less than about 20.1 g-cm, (iii) with respect to a six-layer structure of the composite, the structure has a flexural rigidity of less than about 47.1, and (iv) with respect to an eight-layer structure of the composite, the structure has a flexural rigidity of less than about 86 g-cm. Representative 2-layer, 4-layer, 6-layer, and 8-layer composite materials will therefore meet the flexural rigidity threshold values of less than about 5.2 g-cm, less than about 20.1 g-cm, less than about 47.1 g-cm, and less than about 86 g-cm, respectively. Representative composite materials having other numbers of fibrous layers meet these flexural rigidity criteria (i)-(iv) above, with respect to subset “structures,” having fewer fibrous layers than the number of fibrous layers of the composite. For example, a representative 10-layer composite meets the flexural rigidity criteria (i)-(iv) above if (i) any two-layer structure of this composite has a flexural rigidity of less than about 5.2 g-cm, (ii) any four-layer structure of the composite has a flexural rigidity of less than about 20.1 g-cm, (iii) any six-layer structure of the composite has a flexural rigidity of less than about 47.1, and (iv) any eight-layer structure of the composite has a flexural rigidity of less than about 86 g-cm. A representative 5-layer composite meets the flexural rigidity criteria (i)-(iv) above if (i) any two-layer structure of this composite has a flexural rigidity of less than about 5.2 g-cm, and (ii) any four-layer structure of the composite has a flexural rigidity of less than about 20.1 g-cm. The flexural rigidity criteria (i)-(iv) therefore apply to composites having any number of fibrous layers.

Flexible ballistic resistant armor products comprising one or more composite materials, in addition to having the desirably low stiffness (i.e., good flexibility), low areal density (i.e., light weight), and ballistic performance as described herein, also have an overall system flexibility, measured for a system of composite materials assembled as layers in a stacked relationship, that is suitable for military and/or law enforcement applications. Preferably this overall system flexibility can meet or exceed the U.S. Military Flexibility Requirement for an Improved Outer Tactical Vest (IOTV). For example, flexible ballistic resistant armor products have an overall system flexibility of generally less than about 250 g-cm, and often less than about 225 g-cm. According to representative embodiments, such overall system flexibility values may advantageously be achieved in armor products having from about 40 to about 150, and often from about 50 to about 135, total fibrous layers, which may be obtained, for example, by assembling composites having 2, 4, 6, and/or 8 plies, and/or composites having any other number of plies, in a stacked relationship (e.g., assembling 13 layers of four-ply composites to obtain an armor product having 52 total fibrous layers). The overall system flexibility is determined as the sum of the component flexural rigidities, measured individually according to ASTM D 1388 with respect to each composite material, in a system of composite materials assembled as layers in a stacked relationship. For example, in the case of a single type of composite material that is assembled to form a plurality of layers of a flexible ballistic resistant armor product, the overall system flexibility is the flexural rigidity of that composite material or component (e.g., a two-ply, four-ply, six-ply, or eight-ply composite material), multiplied by the number of such composite materials (i.e., the number of layers of that composite material, as assembled in a stacked relationship). In the case of two types of composite material, Type A and Type B, that are assembled to form a plurality of layers of a flexible ballistic resistant armor product, the overall system flexibility is the flexural rigidity of a single composite material of Type A (component A), multiplied by the number of composite material layers of Type A, added to the flexural rigidity of a single composite of Type B (component B), multiplied by the number of composite material layers of Type B.

As mentioned above, representative composite materials are flexible, based on their relatively low stiffness values, as measured in accordance with ASTM D 4032 (using a 102 mm×102 mm square specimen in single layer form, i.e., without folding). In the case of such representative composite materials, (i) with respect to a two-layer structure of the composite, the structure has a stiffness of less than about 2.6 pounds (1.18 kg) and typically less than about 2.5 pounds (1.14 kg), (ii) with respect to a four-layer structure of the composite, the structure has a stiffness of less than about 3.9 pounds (1.77 kg) and typically less than about 3.0 pounds (1.36 kg), (iii) with respect to a six-layer structure of the composite, the structure has a stiffness of less than about 6.4 pounds (2.90 kg), and (iv) with respect to an eight-layer structure of the composite, the structure has a stiffness of less than about 10 pounds (4.54 kg). Representative 2-layer, 4-layer, 6-layer, and 8-layer composite materials will therefore meet the stiffness threshold values of less than about 2.6 pounds (typically less than about 2.5 pounds), less than about 3.9 pounds (typically less than about 3.0 pounds), less than about 6.4 pounds, and less than about 10 pounds, respectively. Representative composite materials having other numbers of fibrous layers meet these stiffness criteria (i)-(iv) above, with respect to subset “structures,” having fewer fibrous layers than the number of fibrous layers of the composite. For example, a representative 10-layer composite meets the stiffness criteria (i)-(iv) above if (i) any two-layer structure of this composite has a stiffness of less than about 2.6 pounds (typically less than about 2.5 pounds), (ii) any four-layer structure of the composite has a stiffness of less than about 3.9 pounds (typically less than about 3.0 pounds), (iii) any six-layer structure of the composite has a stiffness of less than about 6.4 pounds, and (iv) any eight-layer structure of the composite has a stiffness of less than about 10 pounds. A representative 5-layer composite meets the stiffness criteria (i)-(iv) above if (i) any two-layer structure of this composite has a stiffness of less than about 2.6 pounds, and (ii) any four-layer structure of the composite has a stiffness of less than about 3.9 pounds. The stiffness criteria (i)-(iv) therefore apply to composites having any number of fibrous layers.

The flexibility, weight (areal density), ballistic performance, and flexural rigidity properties, and combinations of such properties of composite materials and armor products, as described herein, are achieved as a result of a number of factors that are apparent to those skilled in the art, having knowledge of the present specification. In addition to the number of fibrous layers (e.g., in terms of its impact on the flexural rigidity of an armor product), such factors include, but are not limited to, the fiber type and fiber areal density used in the fibrous layer(s), polymeric matrix type and composition as it is applied to the fibers (e.g., including an aqueous or organic solvent and possibly other resin composition components), relative amount of polymeric matrix used, and the optional use of films and topical adhesives, as well as the types of films and adhesives, as described above. Conditions for consolidating fibrous layers, and especially consolidation pressure, also impact the properties of composite materials and armor products described herein. It should also be pointed out that the desired properties of armor products may be achieved using materials that are present together with the composite of this invention, in the formation of an armor product or the like. Such additional materials include woven, knitted, or non-woven fabrics and preferably also comprise fibers, including high tenacity fibers and/or other fibers. Representative fibers used in such additional materials include poly(alpha-olefin), aramid, liquid crystal copolyester, and PBO fibers.

Embodiments of the invention are directed to flexible ballistic resistant armor products comprising a composite material having at plurality of fibrous layers, with the fibrous layers comprising fibers and a polymeric matrix deposited on the fibers. Preferably, the composite material has least one of the properties of composite materials (e.g., average total areal density per fibrous layer; fiber type, denier, and areal density; polymeric matrix type, tensile modulus, and relative amount; number of fibrous layers and the use of cross-plying, stiffness criteria for various layer structures, flexural rigidity for various layer structures, etc.) as described above. Preferably, at least one (e.g., one, two, three, four, five, six, seven, etc., or all) of the fibrous layers of the composite material comprises high tenacity fibers, and more preferably comprises fibers having tenacity of at least about 35 g/d and a tensile modulus of at least about 1200 g/d. The armor product preferably has the overall system flexibility as described above. According to embodiments of the invention, a vest or other body armor or other article is formed from a plurality of flexible ballistic resistant composite materials described herein. One or more, and preferably all, of the composite materials have at least one of the properties of composite materials as described above. In the formation of body armor, these composite materials, often assembled in a stacked relationship, preferably are not laminated together but may be stitched together to avoid slippage of the individual plies with respect to each other. For example, the layers may be tack stitched at each corner. Alternatively, the layers may be encased as a whole in a pocket or other covering.

One significant consideration for achieving the desirable properties described herein is obtaining a relatively low total areal density of the fibrous layers of the composite. For example, the total areal density of the composites of this invention is preferably equal to or less than about 100 g/m², and more preferably from about 75 to about 100 g/m², for a two-ply structure of the composite material of this invention. Most preferably the total areal density for such structure is about 97 g/m². For a four-ply structure of the composite material of this invention, the total areal density is preferably equal to or less than about 190 g/m², and more preferably from about 140 to about 190 g/m². Most preferably, the total areal density for a four-ply structure of the composite is about 180 g/m². As used herein, the total areal density of the composite is defined as the weight per unit area of the multi-layer material forming the composite of this invention. Advantageously, in representative composite materials, the average total areal density per fibrous layer (i.e., the total areal density of the composite material, not including outer plastic films if used, divided by the number of fibrous layers) is generally from about 16 g/m² to about 350 g/m², typically from about 16 m²/g to about 300 m²/g, and often from about 20 g/m² to about 150 g/m². Due to the nature of the fiber and polymeric matrix employed in the construction of the fibrous layers of the composite of this invention, such comparatively low total areal densities can be achieved, to the benefit of the end user in terms of overall weight and comfort of the flexible ballistic armor product. Moreover, the relatively low areal density of the fibrous layers results in the presence of a greater number of fibers per weight, in order to provide the desired ballistic properties.

Important properties associated with the overall comfort of users of armor products described herein, including increased flexibility, reduced weight (areal density), and/or reduced flexural rigidity, may be achieved in some cases by providing a textured layer for at least one of the plurality of fibrous layers of a composite material used to form the armor product. By “textured” is meant that a surface of at least one of the fibrous layers (e.g., an outer fibrous layer of a composite material) has raised and depressed areas that (1) are capable of being felt by a human hand and/or (2) form contours that are discernible by a human eye without magnification. By “pattern” it is meant that the raised and depressed areas are distributed in a non-random design or configuration. By “non-random” it is meant that the raised and depressed areas are distributed in a predetermined, uniform manner. Preferably, the surfaces of both outer fibrous layers of a composite material are textured.

Particularly useful patterns are those typically employed for embossing paper and metal sheets. Illustrative of such patterns are linen, plain weave, fine dot, morocco, cracked ice, woodgrain II, hexpin, taffeta, diamond, pony skin, geometric crosses, pique, small checkers, diamond circle, crystal, cobblestone, leaf, Spanish crush, #20 box, #36 kid, #46 canberra and similar patterns. It is clear from this list of various pattern designs that the individual raised and depressed areas can themselves have a wide variety of shapes such as linear, circular or polygonal. For example, linear raised or depressed areas could follow an essentially straight path or it could follow a curved path ranging from wave shape to a tight swirl. In another example, the raised or depressed areas could be in the shape of a circular dot. Of course, a single pattern can include a mixture of different types of shapes. Particularly preferred patterns are linen and morocco (e.g., #43 flat morocco).

The depth of the depressed areas is not critical, however, it should not be so great as to cause such an extensive degree of delamination and/or fiber breakage that the ballistic performance of the composite material is adversely affected. Moreover, the depth of the depressed areas is not so great so as to form areas where the amount of matrix material is substantially less than the amount of matrix material in adjacent areas. In other words, the matrix material is distributed substantially uniformly over the fiber network layer, so that the matrix material/fiber weight ratio is substantially uniform over a fibrous layer.

For forming a textured fibrous layer, any conventional method typically used for embossing paper or metal sheets should be capable of applying the texturing. Since the composite material has high strength, a matching or male/female embossing system is preferred. In general, a sheet of the fibrous layer, or composite material comprising multiple fibrous layers, is placed between a pressing surface having a plurality of raised bosses and a backing surface that is the complementary negative of the pressing surface. In other words, the pressing surface and the backing surface are aligned in an opposing male/female relationship so that the raised bosses of the pressing surface conform to the complementary recesses in the backing surface. The raised bosses are in a pattern which is the mirror image of the desired textured pattern. The pressing surface and the backing surface then are simultaneously brought into contact with the surfaces of the fibrous layers to be embossed or textured.

The pressing and backing surfaces can be carried on a plate or a roll. The surfaces can be an integral part of the plate or roll or they can be made of a material that is different from that of the plate or roll. For example, the backing surface can be a sheet of hard paper wrapped around a metal roll. Illustrative of pressing and backing surface materials that can be used include metal, hard paper and hard plastic.

As noted above, the fibers (e.g., high tenacity fibers) of each fibrous layer are coated with the matrix composition and then the matrix composition/fibers combination is consolidated. By “consolidating” is meant that the matrix material and the fibers are combined into a single unitary layer. Consolidation can occur via drying, cooling, heating, pressure or a combination thereof.

Various constructions are known for fiber-reinforced composites used in impact and ballistic resistant articles. These composites display varying degrees of resistance to penetration by high speed impact from projectiles such as bullets, shrapnel and fragments, and the like. For example, U.S. Pat. Nos. 6,219,842; 5,677,029, 5,587,230; 5,552,208; 5,471,906; 5,330,820; 5,196,252; 5,190,802; 5,187,023; 5,185,195; 5,175,040; 5,167,876; 5,165,989; 5,124,195; 5,112,667; 5,061,545; 5,006,390; 4,953,234; 4,916,000; 4,883,700; 4,820,568; 4,748,064; 4,737,402; 4,737,401; 4,681,792; 4,650,710; 4,623,574; 4,613,535; 4,584,347; 4,563,392; 4,543,286; 4,501,856; 4,457,985; and 4,403,012; PCT Publication No. WO 91/12136 all describe ballistic resistant composites which include high strength fibers made from high molecular weight polyethylene.

Representative flexible ballistic resistant armor products of this invention have a V50 of at least about 488 meters per second (mps) or about 1600 feet per second (fps), preferably at least about 503 mps (1650 fps) when impacted with a 124 grain, 9 mm full metal jacket bullet, generally for a total weight of armor product of 4.89 kg/m² or less, typically for a total weight of armor of 4.40 kg/m² or less, and often for a total weight of armor product of 3.68 kg/m² or less. Such performance properties may be achieved, for example, using two-ply, four-ply, six-ply, and/or eight-ply composite materials, when tested in accordance with MIL-STD-662E. For exemplary armor products based on a two-ply composite, the products may be characterized as having a V50 of at least about 458 mps (1500 fps), preferably at least about 465 mps (1525 fps) when impacted with a 240 grain, 44 magnum semi-jacketed hollow point bullet, when tested in accordance with MIL-STD-662E. These properties are determined using a shoot pack of 45.7×45.7 cm (18×18 inches) having a weight of 3.68 kg/m² (0.75 pounds per square foot).

As is known in the art, the V50 velocity is that velocity for which the projectile has a 50% probability of penetration.

Representative armor products of this invention based on four-ply construction have, in terms of ballistic performance, a V50 of at least about 519 mps (1700 fps) when impacted with a 124 grain, 9 mm full metal jacket bullet, more preferably a V50 of at least about 526 mps (1725 fps) when tested in accordance with MIL-STD-662E. Such representative armor products based on a four-ply construction may also have a V50 of at least about 473 mps (1550 fps), preferably at least about 480 mps (1575 fps), when impacted with a 240 grain, 44 magnum semi-jacketed hollow point bullet when tested in accordance with MIL-STD-662E. These properties are determined on the same shoot pack as with the 124 grain, 9 mm full metal jacket bullet described above.

Representative armor products of this invention may also be characterized, in terms of ballistic performance, as having a V50 of at least about 556 mps (1825 fps), more preferably at least about 572 mps (1875 fps) when impacted with a 17 grain Fragment Simulating Projectile (FSP) per MIL-STD-662E, for a construction based on a two-ply composite. The fragment was as specified by MIL-P-46593A (ORD), caliber=.22. Representative armor products based on a four-ply construction preferably also have a V50 of at least about 572 mps (1875 fps), more preferably at least about 579 mps (1900 fps) when impacted with the same 17 grain FSP. These properties are determined using a shoot pack of 45.7×45.7 cm (18×18 inches) having a weight of 1.00 pounds per square foot (4.89 kg/m²).

Additionally, composite materials of this invention are characterized in relatively low peel strengths, as measured by a modified version of ASTM D3330. The peel strength as described herein is referred to as Peel Strength in the following description and in the claims.

The Peel Strength test is conducted to measure the Peel Strength between the layers of two or more materials bonded together. For testing the Peel Strength between layers of cross-plied material, with or without lamination between plastic films, three samples per material are cut from the sheet of cross-plied material. Care is taken to follow the fiber direction during cutting the sample. The sample size is 5 cm wide×28 cm long (2 inches wide×11 inches long).

To determine the bond strength of a 2-ply material or the outer layers of a 4-ply material (what is referred to as the 1-2 bond and the 3-4 bond) a strip 1 inch (2.5 cm) wide of the 2 inch (5 cm) wide sample is peeled down the center, leaving 0.5 inch (1.25 cm) on each edge of cross-directional fibers. This is necessary to hold the other side of the material since that side is the cross-directional fiber side and does not have the strength to be peeled without some of the machine directional fibers being present in the clamp together with the cross-directional fibers.

Each test sample is peeled up to 2 inch (5 cm) length so that the sample can be gripped in an Instron testing machine. Once the sample is firmly clamped into the grips of the machine, the test is started to peel the sample at a cross-head speed of 10 inches (25.4 cm)/min A 5 inch (12.7 cm) length of the sample is peeled in the machine. The peel force is recorded and the average peak peel force (of the top 5 peaks) and the average peel force are calculated.

Three identical peels are tested for each interface of each sample and the average peel strength is reported for each interface of each sample. There is one interface tested for a two-ply sample (the 0°/90° interface) and 3 interfaces tested for a four-ply sample (the 0°/90°, 90°/0° and 0°/90° interfaces).

The procedure for the 4-ply material is the same, except to measure the 2-3 layer bond Peel Strength the sample size is cut to 1 inch wide×11 inches (2.5×28 cm) long and one half of the thickness of the sample (film and)0°/90° is peeled from the other half of the sample (film and) 0°/90°, since both halves have machine direction fibers to provide the strength to the strip for peeling.

For the two-ply composite of this invention, preferably the Peel Strength is less than about 1.0 pounds (0.45 kg), and more preferably less than about 0.9 pounds (0.41 kg). The Peel Strength for a two-ply composite is measured between the two plies (e.g., between the 0° ply and the 90° ply in a cross-plied construction). For the four-ply composite of this invention, the Peel Strength is preferably less than about 0.7 pounds (0.32 kg), and more preferably less than about 0.6 pounds (0.27 kg). The Peel Strength for a four-ply composite is measured between the second and third layers, (e.g., between the first 0°/90° ply and the second 0°/90° ply in a 0°/90°/0°/90° construction).

Compared with existing commercial products based on poly (alpha-olefin) fibers, the ballistic composites of this invention have lower fiber areal density, higher V50 ballistic properties, and lower stiffness (higher flexibility). The composites of this invention are further characterized in having lower Peel Strengths than conventional poly(alpha-olefin) ballistic composites.

As mentioned above, the flexible or soft armor of this invention is in contrast to rigid or hard armor. The flexible materials and armor of this invention do not retain their shape when subjected to a significant amount of stress and are incapable of being free-standing without collapsing.

The following non-limiting examples are presented to provide a more complete understanding of the invention. The specific techniques, conditions, materials, proportions and reported data set forth to illustrate the principles of the invention are exemplary and should not be construed as limiting the scope of the invention. All percentages are by weight, unless otherwise stated.

### EXAMPLES

### Examples 1 and 2

A two-ply non-woven composite was formed from layers of extended chain Spectra® 1000 polyethylene fiber from Honeywell International Inc. The fiber had a tenacity of 36.6 g/d, a tensile modulus of 1293 g/d and an ultimate elongation of 3.03 percent. The yarn denier was 1332 (240 filaments). Uni-directional preimpregnated tapes (“unitapes”) of these fibers were prepared and a matrix resin was coated thereon. The matrix resin was Prinlin® B7137HV (from Pierce & Stevens Corp.), which is a water based dispersion of Kraton® D1107 styrene-isoprene-styrene resin block copolymer. This product is described by its manufacturer as comprising, by weight, 68.7% Kraton® D1107, 22.7% of a wood rosin derivative as a resin modifier, 3.9% of a nonionic surfactant, 2.1% of an anionic surfactant, 2.3% of an antioxidant and 0.3% of sodium hydroxide, and a viscosity at 77° F. (25° C.) of 400 cps. The amount of styrene in the polymer is described as 14% by weight, and the particle size is described as 1-3 μm. Following coating, the water is evaporated from composition and the fiber network was wound up on a roll. Two continuous rolls of unidirectional fiber prepregs were prepared in this manner. Two such unitapes were cross-plied at 90° and consolidated under heat and pressure to create a laminate with two identical polyethylene fiber lamina. The resulting structure contained 15 weight percent of the elastomeric resin. Two such two-ply consolidated structures were then cross-plied once again at 90°, and consolidated under heat and pressure. The resulting structure was a 4-ply polyethylene fiber composite.

Both the two-ply and the four-ply consolidated layers (Examples 1 and 2, respectively) were sandwiched between two LLDPE films (thickness of approximately 0.35 mil (8.9 μm)) under heat and pressure. Samples of these materials measuring 18×18 in. (45.7×45.7 cm) were tested for their ballistic properties and their flexibility properties. The Example 1 samples had a thickness of 0.005 inch (0.127 mm) and the Example 2 samples had a thickness of 0.009 inch (0.229 mm) Ballistic testing for the 124 grain, 9 mm FMJ bullets and 240 grain, 44 magnum semi-jacketed hollow point bullets were conducted as per MIL-STD-662E, and the backing of the shoot pack was clay. Ballistic testing for the 17 grain FSP was conducted as per MIL-STD-662E, and the backing of the shoot pack was air. For the 9 mm and 44 magnum ballistic tests, the total areal density was 0.75 pounds per square foot (3.68 kg/m²). As such, the shoot packs included 39 layers of the 2-ply composite (including films) and the 21 layers of the 4-ply composite (including films). For the 17 grain FSP ballistic tests, the total areal density was 1.00 pounds per square foot (4.89 kg/m²). As such, the shoot packs included 51 layers of the 2-ply composite (including films) and 27 layers of the 4-ply composite (including films).

The results are shown in Table 1 for the different ballistic tests.

### Examples 3 and 4

### Comparative

For comparative purposes, samples of commercially available polyethylene fiber based composites were tested for their properties. The results are also shown in Table 1, below. Example 3 was Spectra Shield® Plus LCR from Honeywell International Inc. (having a thickness of 0.006 inch (0.152 mm)), which is a two-ply cross-plied laminate of Spectra® 1000 fibers (1100 denier), with a Kraton®D1107 styrene-isoprene-styrene (SIS) resin applied from an organic solvent, and having a resin content of about 20% by weight. Example 4 was a commercially available, two-ply cross-plied laminate of polyethylene fibers, with an SIS resin.

TABLE 1

| | | | 44 | 17 Grain | | Peel |
|---|---|---|---|---|---|---|
| | Total Areal | 9 MM FMJ¹ | Magnum¹ | FSP² | Stiffness, | Strength, |
| | Density | V50, fps | V50, fps | V50, fps | lbs | lbs |
| Example | (g/m²) | (mps) | (mps) | (mps) | (kg) | (kg) |
| 1 | 97 | 1697 | 1530 | 1951 | 1.9 | 0.845 |
| (two-ply) | | (517.6) | (466.7) | (595.1) | (0.86) | (0.384) |
| 2 | 180 | 1758 | 1599 | 1956 | 2.7 | 0.100 |
| (four-ply) | | (536.2) | (487.7) | (596.6) | (1.23) | (0.045) |
| 3 | 118 | 1560 | 1421 | 1756 | 3.0 | 2.35 |
| (comp.) | | (475.8) | (433.4) | (535.6) | (1.36) | (1.066) |
| 4 | 132 | 1642 | 1533 | — | 3.0 | 3.91 |
| (comp.) | | (500.8) | (467.6) | | (1.36) | (1.774) |

¹= weight of shoot pack 0.75 psf (3.68 kg/m²)
²= weight of shoot pack = 1.00 psf (4.90 kg/m²)

It can be seen that the two-ply and four-ply ballistic materials not only have the highest ballistic resistance against a 124 grain, 9 mm FMJ hand-gun bullet, but also have either the same or higher ballistic resistance against a 44 magnum highly deformable bullet. This is surprising for a ballistic material that has excellent flexibility.

Also, surprisingly, the composite material of this invention has excellent fragment resistance against 17 grain, 22 caliber Fragment Simulating Projectiles.

The two-ply product also has the highest flexibility compared with the comparison products. Higher flexibility is very desirable because it provides comfort in a ballistic vest. Such vests may be worn by military personnel or law enforcement officers during their long hours at duty.

Accordingly, it can be seen that the present invention provides a ballistic composite and articles formed therefrom that have improved flexibility and excellent ballistic resistance. The present invention also provides a process for making the improved flexible composites.

Having thus described the invention in rather full detail, it will be understood that such detail need not be strictly adhered to but that further changes and modifications may suggest themselves to one skilled in the art, all falling within the scope of the invention as defined by the subjoined claims.

1. A flexible ballistic resistant composite material comprising a plurality of fibrous layers, wherein each layer comprises:
(a) fibers having a tenacity of at least about 35 g/d and a tensile modulus of at least about 1200 g/d, and
(b) a polymeric matrix deposited on the fibers,
wherein the composite material has an average total areal density per fibrous layer from about 16 g/m² to about 350 g/m², and
wherein, (i) with respect to a two-layer structure of the composite, the structure has a flexural rigidity of less than about 5.2 g-cm, (ii) with respect to a four-layer structure of the composite, the structure has a flexural rigidity of less than about 20.1 g-cm, (iii) with respect to a six-layer structure of the composite, the structure has a flexural rigidity of less than about 47.1, and (iv) with respect to an eight-layer structure of the composite, the structure has a flexural rigidity of less than about 86 g-cm, as measured according to ASTM D 1388.

2. The composite material of claim 1, having an average total areal density per fibrous layer from about 16 g/m² to about 300 g/m².

3. The composite material of claim 1, having a fiber areal density, in each of the plurality of fibrous layers, from about 15 g/m² to about 250 g/m².

4. The composite material of claim 1, wherein the polymeric matrix is an elastomer having a tensile modulus of about 41.4 MPa or less, as measured according to ASTM D 638.

5. The composite material of claim 1, wherein the polymeric matrix is selected from the group consisting of polybutadiene, polyisoprene, natural rubber, an ethylene copolymer, an ethylene-propylene-diene terpolymer, a polysulfide polymer, a polyurethane elastomer, chlorosulfonated polyethylene, polychloroprene, plasticized polyvinylchloride, a butadiene acrylonitrile elastomer, poly(isobutylene-co-isoprene), a polyacrylate, a polyester, a polyether, a silicone elastomer, and blends thereof.

6. The composite material of claim 1, wherein the polymeric matrix is a block copolymer of a conjugated diene monomer and a vinyl aromatic monomer.

7. The composite material of claim 6, wherein the conjugated diene monomer is butadiene or isoprene.

8. The composite material of claim 6, wherein the vinyl aromatic monomer is styrene, vinyl toluene, or t-butyl styrene.

9. The composite material of claim 8, wherein the polymeric matrix is a styrene-isoprene-styrene block copolymer that is modified with wood rosin or a wood rosin derivative.

10. The composite material of claim 1, wherein the polymeric matrix is present in an amount from about 7% to about 25% by weight.

11. The composite material of claim 1, wherein the fibers have a denier from about 400 to about 3000.

12. The composite material of claim 1, comprising from about 2 to about 8 fibrous layers.

13. The composite material of claim 1, wherein at least one layer of said plurality of fibrous layers is a textured layer.

14. The composite material of claim 1, wherein adjacent fibrous layers are cross-plied with respect to one another.

15. The composite material of claim 1, wherein said fibers in at least one of said fibrous layers comprise extended chain polyethylene fibers.

16. A flexible ballistic resistant armor product comprising a composite material of claim 1, wherein the armor product has a V50, for a total weight of the armor product of 4.89 kg/m² or less, of at least about 556 mps when impacted with a 17 grain Fragment Simulating Projectile meeting the specifications of MIL-P-46593A (ORD).

17. The flexible ballistic resistant armor product of claim 16, having an overall system flexibility of less than about 250 g-cm.

18. A flexible ballistic resistant composite material comprising a plurality of fibrous layers, wherein each layer comprises:
(a) fibers having a tenacity of at least about 35 g/d and a tensile modulus of at least about 1200 g/d, and
(b) a polymeric matrix deposited on the fibers,
wherein the composite material has an average total areal density per fibrous layer from about 16 g/m² to about 350 g/m², and
wherein, (i) with respect to a two-layer structure of the composite, the structure has a stiffness of less than about 2.6 pounds (1.18 kg), (ii) with respect to a four-layer structure of the composite, the structure has a stiffness of less than about 3.9 pounds (1.77 kg), (iii) with respect to a six-layer structure of the composite, the structure has a stiffness of less than about 6.4 pounds (2.90 kg), and (iv) with respect to an eight-layer structure of the composite, the structure has a stiffness of less than about 10 pounds (4.54 kg), as measured according to ASTM D 4032.

19. The composite material of claim 18, wherein (i) with respect to a two-layer structure of the composite, the structure has a stiffness of less than about 2.5 pounds (1.14 kg), and (ii) with respect to a four-layer structure of the composite, the structure has a stiffness of less than about 3.0 pounds (1.36 kg).

20. The composite material of claim 18, having an average total areal density per fibrous layer from about 16 g/m² to about 300 g/m².

21. The composite material of claim 18, having a fiber areal density, in each of the plurality of fibrous layers, from about 15 g/m² to about 250 g/m².

22. The composite material of claim 18, wherein the polymeric matrix is an elastomer having a tensile modulus of about 41.4 MPa or less, as measured according to ASTM D 638.

23. The composite material of claim 18, wherein the polymeric matrix is selected from the group consisting of polybutadiene, polyisoprene, natural rubber, an ethylene copolymer, an ethylene-propylene-diene terpolymer, a polysulfide polymer, a polyurethane elastomer, chlorosulfonated polyethylene, polychloroprene, plasticized polyvinylchloride, a butadiene acrylonitrile elastomer, poly(isobutylene-co-isoprene), a polyacrylate, a polyester, a polyether, a silicone elastomer, and blends thereof.

24. The composite material of claim 18, wherein the polymeric matrix is a block copolymer of a conjugated diene monomer and a vinyl aromatic monomer.

25. The composite material of claim 24, wherein the conjugated diene monomer is butadiene or isoprene.

26. The composite material of claim 24, wherein the vinyl aromatic monomer is styrene, vinyl toluene, or t-butyl styrene.

27. The composite material of claim 26, wherein the polymeric matrix is a styrene-isoprene-styrene block copolymer that is modified with wood rosin or a wood rosin derivative.

28. The composite material of claim 18, wherein the polymeric matrix is present in an amount from about 7% to about 25% by weight.

29. The composite material of claim 18, wherein the fibers have a denier from about 400 to about 3000.

30. The composite material of claim 18, comprising from about 2 to about 8 fibrous layers.

31. The composite material of claim 18, wherein at least one layer of said plurality of fibrous layers is a textured layer.

32. The composite material of claim 18, wherein adjacent fibrous layers are cross-plied with respect to one another.

33. The composite material of claim 18, wherein said fibers in at least one of said fibrous layers comprise extended chain polyethylene fibers.

34. A flexible ballistic resistant armor product comprising a composite material of claim 18, wherein the armor product has a V50, for a total weight of the armor product of 4.89 kg/m² or less, of at least about 556 mps when impacted with a 17 grain Fragment Simulating Projectile meeting the specifications of MIL-P-46593A (ORD).

35. The flexible ballistic resistant armor product of claim 34, having an overall system flexibility of less than about 250 g-cm.

36. A flexible ballistic resistant armor product comprising a composite material having a plurality of fibrous layers comprising fibers and a polymeric matrix deposited on the fibers,
wherein fibers of a least one of said plurality of fibrous layers has a tenacity of at least about 35 g/d and a tensile modulus of at least about 1200 g/d, and
wherein the flexible ballistic resistant armor product has an overall system flexibility of less than about 250 g-cm.

37. The armor product of claim 36, having an overall system flexibility of less than about 225 g-cm.

38. The armor product of claim 36 comprising a plurality of composite materials assembled in a stacked relationship.

39. The armor product of claim 38, wherein each of the plurality of composite materials comprises from about 2 to about 8 fibrous layers.
